(19) United States
(12) Patent Application Publication
(10) Pub. No.: US 2015/0286650 A1
(43) Pub. Date: Oct. 8, 2015

(54) Decision Making and Activity Recommendations Engine via Online Persona

(71) Applicant: Kurt Stump, San Diego, CA (US)

(72) Inventor: Kurt Stump, San Diego, CA (US)

(21) Appl. No.: 14/244,309

(22) Filed: Apr. 3, 2014

(51) Int. Cl. G06F 17/30; G06Q 50/00

(52) U.S. Cl. CPC G06F 17/3097; G06Q 50/01

(57) ABSTRACT

A system for decision making and activity recommendations. The invention comprises a system whereby a user can generate personalized activity recommendations by using a user's online persona, comprised of information from any or all of the user or users' profiles, preferences, settings, past experiences, and data and associated connections from their social networks and Internet activity. A user can then share their recommendations via the invention, their mobile devices, social networks, and Internet websites. Recommendations can then be used to facilitate the user's life, e.g. send communications, acknowledgements, reservation requests, calendar events, etc. Users can share, link, and store their activities for better recommendations and collaboration in the future.

### CROSS-REFERENCE TO RELATED APPLICATIONS

This application claims priority to U.S. Provisional Patent Application No. 61/812,673 entitled Decision Making and Activity Recommendations Engine via Online Persona filed Apr. 16, 2013, which is incorporated herein by reference for all purposes.

### STATEMENT REGARDING FEDERALLY-SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### FIELD OF THE INVENTION

This invention relates to the field of computer software programs, online social networking services, and online activity data. More specially, the invention comprises a system whereby a user can generate and share a personalized life activity recommendation based on any or all of the information from their personal profile, preferences, social networking data, online Internet activity data, past experiences, preferences, and currently-selected settings. This recommendation can then be accepted into the user's life, equivalent to a decision on what they should do with their lives. All user input data is recorded by the system for future use.

### BACKGROUND OF THE INVENTION

A software application is a software program that runs natively on a computing platform's operating system.

A web application (also known as a “web app” or “webapp”) is a software program that runs on a computer operating system and is accessible over a communications network such as the Internet or a local intranet. Web applications are popular due to the prevalence of web browsers that act and display information similarly on various different computer platforms, and the convenience of using a web browser as a client with a single, centralized code base. Examples of web applications include Internet-based email, online banking, online auctions, wikis, and many other functions.

Mobile devices, such as smart phones, tablet PCs, other portable handheld devices, and hands-free/heads-up devices have become widespread and important to the daily activities of many consumers, drivers, and businesses. Traditionally, these types of devices have primarily served as communications devices. However, consumers are increasingly using these devices as an integral tool in a wide-range of personal and business-related tasks.

These mobile devices generally provide other various functionalities apart from voice calls and messaging, including accessing and displaying websites, sending and receiving e-mails, registering and storing their current and favorite locations (also known as “check-ins”), taking and displaying photographs and videos, receiving information from peripherals, registering biological information from the user, playing music and other forms of audio, sharing information on social networks, etc. These, and other functionalities, are generally performed by software applications either in the form of software components that are built-in to the device's mobile operating system or separate mobile applications (also known as “mobile apps” or “apps”) that run on the device's operating system. Recently, the development and use of mobile apps has become prevalent and now exist across a wide array of mobile device platforms.

Online, Internet-based social networking services are popular across a wide demographic of users, and the field in general is experiencing substantial growth. At the most basic level, social networking involves connecting users with each other to communicate and share information. Users typically establish accounts and create profiles containing biographical data such as current location, schools attended, employment experiences, personal relationships, and so forth. Furthermore, various updates of interests with messages, established and implied preferences for items, locations, and concepts, locations visited, photographs, videos, activities on other websites (also known as their “preferences” or “likes”), and links to other sites may be posted on their social networking profile (collectively known as their “online persona”). Access to this online persona and its accompanying personal information may be limited to others that have established and approved relationships with this user's account (also known as “connections,” “links,” “friends” or “followers”). Depending on preference, information may be made accessible to secondary contact links, or to all users on the social networking service. A group of contacts, which can mirror the user's real-life personal network of friends, colleagues, and acquaintances, may thus be established online, and a variety of content can be exchanged.

There are many social networking sites currently online, and beyond basic networking and messaging functionalities, may be configured for specific purposes and uses. For example, services such LinkedIn is targeted for business-oriented uses in which users post relevant employment-related content, whereas services such as Facebook and MySpace are geared more toward social and entertainment uses. Yelp is geared for ratings and reviews of locations. Services such as Twitter provide “live-update” type features and services such as Foursquare contemplate location-based updates. However, social networking sites can and do overlap functionality.

A common use in social networking is receiving recommendations based on the user's online persona. This process exists today by correlating the likes of the current user with the likes of other users. In its most basic form, if User 1 likes items A, B, and C while User 2 likes items X, B, and C, User 1 will be presenting with the concept of liking Item X while User 2 will be presented with liking Item A. This is because the two users have likes of Item B and Item C in common. Other forms of receiving recommendations include the social networking sites recommending goods and/or services based on the paid advertising of the uncorrelated likes of other users who are linked with the current user.

Accordingly, there is a need in the art for leveraging the user's online persona to make or assist with making activity decisions and recommendations for their online and real lives (also known as “actual events and interactions with people not based online”).

### BRIEF SUMMARY OF THE PRESENT INVENTION

The present invention comprises a system in the form of a native application, webapp, and mobile app that generates recommendations for activities in the users' lives such as, but not limited to, what to do, where to go, what to eat, who to meet, when to do something, which life events to undertake, etc. (also known as “activities”). This information is based on the user's present company, either alone or in a group of various genders and ages, their online persona, the online personas of the others in their group, their personal profile(s) and linked profiles, social networking data, online activity data, past experiences and system usage, preferences, information about the date, time, and their location, and currently-selected settings that describe the present situation.

Historical uses of the present invention are also used in providing recommendations and thus create a system of computer learning, whereby the application can learn about the user and their preferences and continue to provide more targeted recommendations for themselves, their socially-networked connections, and other non-connected users with continued use. All available, retrieved information is organized in a data model where the data is statistically modeled, a selection algorithm is applied, and a recommendation is generated.

The recommendation may be accepted, weighted, or rejected. If the recommendation is accepted, the user will be prompted to share or broadcast their recommendation and to include others via the present invention or via social networks or via Internet websites. If the recommendation is graded, the user will be prompted to assign positive or negative weighting (also known as a “weighting,” “thumbs up,” “thumbs down,” “+1,” or “−1”) to this activity or to remove it all together from their future uses of the present invention. If the recommendation is rejected, the present invention will generate a new recommendation based on the currently-selected settings or allow the user to select new settings. Whether the recommendation is accepted, graded, or rejected the system retains this information for modeling future recommendations more accurately.

The present invention will allow users to modify the activities available to the system, by creating new activities, importing new activities, and sharing new or modified activities with socially-networked connections and other system users. Users may create, import, modify, or link to a third-party profile for use by the current invention. Users may receive and share activities with their socially-networked connections and receive and share activities with all users of the present invention and Internet websites. The present invention provides for the centralization and storage of all recommendation and activity data for use in future recommendations and activities for all users. The present invention will also allow for both paid and unpaid advertisements and/or endorsements of specific items, locations, activities, events, sales, coupons, and offerings.

The present invention's generated recommendations can then be effectively accepted into the user's life, equivalent to a life decision on what they should do now or in the future, via processing by the user's device, the device of a user's social connection, social networks, Internet websites, and the present invention's centralized portal. This processing entails both automated and prompted responses to make reservations, respond with acknowledgements of reservations, send information to a GPS (also known as a “global positioning system”), mapping, or direction-providing appliances for navigational purposes, send information to geographic check-in or tracking appliances, make calendar appointments for the user and/or their group, update out of office messages and standards greeting on all of their forms of electronic communication, and notify a contact list of their plans to engage in the generated recommendation.

### BRIEF DESCRIPTION OF THE DRAWINGS

FIG. 1 is a block diagram which shows the present invention's logical relation to its use by one or more users and its connectivity to social networking systems, the Internet, and the present invention's centralized implementation. Consistent with embodiments of the present invention, Present invention local implementation 50 may comprise a plurality of client devices such as personal computers, laptops, smart phones, tablets, smart watches, wearable technology, and other handheld/hands-free devices, a communications software application that provides interface capability for other components, a memory buffer unit for storing incoming and/or outgoing data, and a control unit that may include a processing unit and a memory unit.

FIG. 2 is a block diagram which shows how the present invention works to provide current and future recommendations using cached and live activity data in social networks and the public Internet.

FIG. 3 is a flow chart representing an example first use of the present invention.

### REFERENCE NUMERALS IN THE DRAWINGS

10 User
11 Potential group accompanying the User
30 Present Invention's communications processor, which processes the data and houses the selection algorithm
31 Present invention's data model, a statistical tool for generating personalized recommendations
32 Data storage memory buffer for all social network data, online activity data, profile data, preference data, and all other retrieved data
33 Activity data storage memory buffer
40 Collection of all public Internet websites
41 Collection of all social networking websites
42 Representation of the Public Internet, e.g. the publicly-addressable network between disparate systems or private networks
43 Present invention's centralized software program, comprised of a communications processor, web service, and data repository (also known as present invention's “centralized portal”)
44 Present invention's centralized web server or collection of web servers
45 Present invention's centralized data repository memory buffer
50 Present invention's local implementation
51 Example client devices that the present invention resides on
52 Present invention's recommendation engine
60 User's interaction with the present invention
61 User's interaction with the User's accompanying group
62 Logical connection between the present invention and the client systems it resides on
63 Connection from present invention to the Internet or private network
64 High-speed connections within the Internet
65 Logical connections between the present invention and its components
200 User or the representation of a group of users
201 Present invention's local implementation's control system
202 Collection of all public Internet websites
203 Collection of all social networking websites
204 Present invention's centralized portal
205 Representation of the Public Internet, e.g. the publicly-addressable network between disparate systems or private network
206 Secure login mechanism of the present invention
210 Data storage for all social network data, online activity data, online and local profile data, preference data, and all other retrieved data
211 Activity storage data
212 Data storage for all activities shared and received via social networking, Internet websites, and the present invention
213 Data storage for all past activity and usage of the present invention
214 Data storage for all activity preferences retrieved from social networking, the user's profile(s), and the present invention
220 Present invention's data model
221 User's customized and personalized recommendation result
222 Present invention's selection algorithm for generating recommendations
260 User's interaction with the present invention
261 Connection from present invention to the Internet or private network
262 High-speed connections within the Internet or private network
263 Logical connections between the present invention and the present invention's data storage
264 Logical connections between the present invention's data storage and data model
265 Logical connections between the present invention's data model, selection algorithm, and recommendations
266 Connection from present invention to the Internet or private network
268 Logical connection between the present invention's secure login mechanism and control system
300 Flow chart processing step and start
301 Flow chart processing step
302 Flow chart processing step
303 Flow chart processing step
304 Flow chart processing step
305 Flow chart processing step
306 Flow chart processing step
307 Flow chart processing step
308 Flow chart processing step
309 Flow chart conditional
310 Flow chart conditional
311 Flow chart conditional
312 Flow chart processing step
313 Flow chart processing step and end

### DETAILED DESCRIPTION

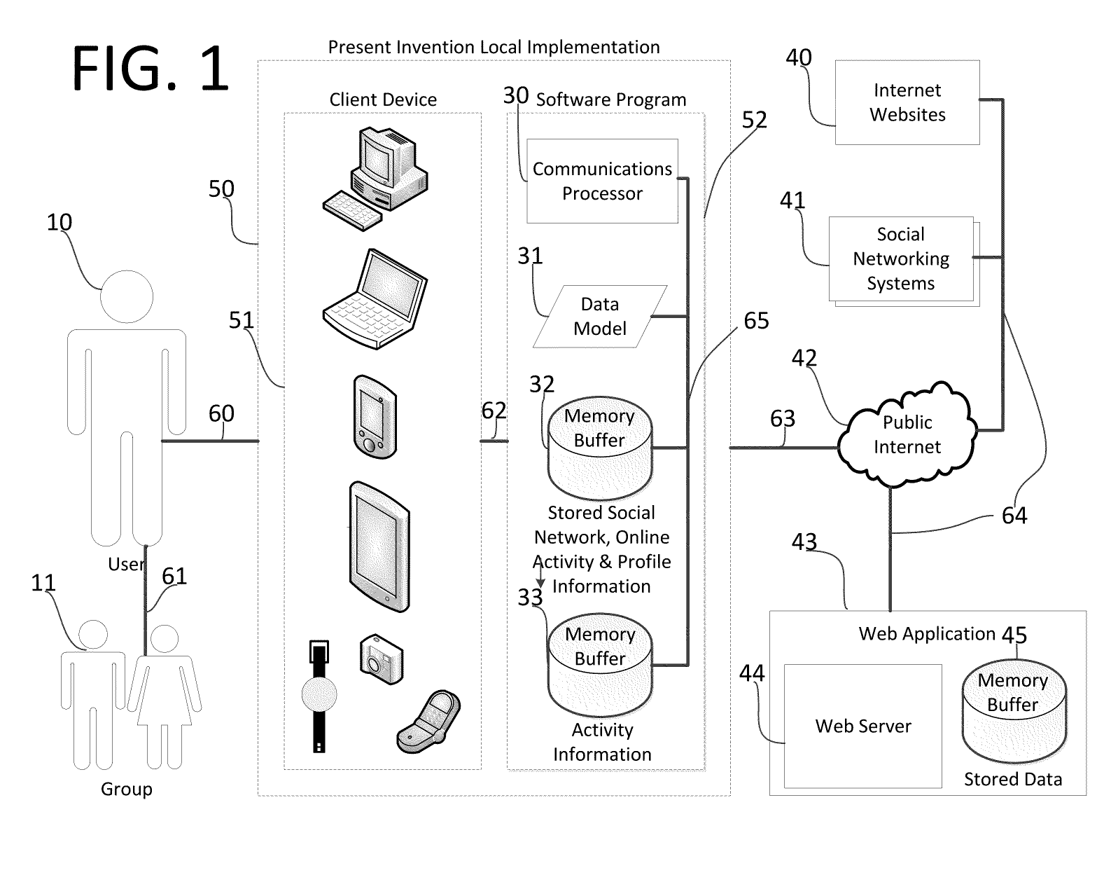

FIG. 1 shows a block diagram which shows the present invention's relation to its use by its user 10 or additional group 11 members and its connectivity to social networking sites and the Internet (explained subsequently). Connection 61 represents the connection between the current user 10 and a group 11 of people engaged in the use of the present invention with them. Connection 61 could also be non-existent if the current user is alone at the present moment. Connection 61 represents a logical connection with the group 11 of users in the same physical location with user 10 as the only interfacing user of the present invention. Connection 61 also represents a connection with the group 11 of users either in the same location or anywhere in the world via the present invention, social networking sites, Internet websites, or connections between the devices of user 10 and the group 11. The present invention can be spanned across devices to allow multiple users to merge their profiles, preferences, and online personas into either a temporary or permanent combination and a unified experience using the present invention. Connection 61 may operate as an Internet Protocol (IP) connection, a Bluetooth connection, a Wi-Fi connection, a hard-wired connection, or any other wireless data connection. Those skilled in the art will appreciate that other data transmission types may be used without limiting the scope of the present invention.

Connection 60 is the interaction between user 10 and the present invention local implementation 50. This interaction is via a computer user interface, mobile device, and any other device that connects to the Internet. Connection 60 is the use of a computer application, a mobile app, a webapp, or a device which specifically executes the present invention. Connection 60 also represents a logical connection between group 11 and the present invention, where group 11 is not actively interfacing with the present invention but the present invention is making recommendations on their behalf. Alternatively, Connection 60 is also the connection between group 11 that is linked to user 10 for user 10's connection to the present invention or user 10 and group 11's unified connection to the present invention. Connection 60 is a tactile use of a device, a series of audio commands, body gestures, eye movements, and biological indicators. Connection 60 is the transmission of biological, calendar scheduling, contact information, communication history, and weather-related information. Those skilled in the art will appreciate that other interface types may be used without limiting the scope of the present invention.

Present invention local implementation 50 represents the usage of the present invention, either directly or vicariously through another user, via a local implementation of the present invention or via a remote implementation available over the Internet or another network. Present invention local implementation 50 is executable computer code, both compiled and interpreted; a logical process built directly from hardware components, and stored data. Client device 51 is an example of devices and terminals and computers that can execute a local implementation of the present invention or via a remote implementation available over the Internet or another network. Client device 51 includes any computing device that can execute application software. Client device 51 includes devices that have multiple purposes and devices dedicated solely to the present invention. Connection 62 is the logical representation of the present invention's user interface and all interfaces through which user 10 can execute, send, or receive recommendations or data from the present invention. Those skilled in the art will appreciate that other communication devices may be used without limiting the scope of the present invention.

Software program 52 represents the computer software, computer hardware, permanent storage, temporary storage, local storage, algorithms, data models and all logic that comprises the present invention. Those skilled in the art will appreciate that other computational devices may be used without limiting the scope of the present invention, including neural net computers, non-binary computers, and learning computer systems. Those skilled in the art will also appreciate that other architectures and configurations of software, hardware, and data may be used without limiting the scope of the present invention.

Communications processor 30 represents the computer software and control logic that comprises the present invention local implementation 50. All logic contained within the present invention is housed and executed in communications processor 30. Communications processor 30 orchestrates the process flow of the present invention. Communications processor 30 houses the selection algorithm and all other logic used in packaging and acquiring data and then generating a recommendation. Data model 31 represents the data model whereby all data stored in or collected by the present invention local implementation 50 is logically stored and data relationships are created and established. The present invention transforms all available data about the user's online history and profile information into correlation tables within data model 31 for generating recommendations. Data model 31 is a statistical tool which process data and updates the data model in real-time and in periodic batches. Data model 31 is computer software, computer hardware, data storage, correlations, and logical relationships between the data.

Stored Social Network, Online Activity & Profile Information 32 represents the data storage memory buffer where all internal and external data relating to social network site data, online Internet website activity data, profile data, lists of socially-networked connections and their associations to the present invention, and all other collected and cached data is stored. Stored Social Network, Online Activity & Profile Information 32 is a relational database management system (also known as “DBMS”), tables, or data elements which store data on a hard disk, solid state disk, and in active memory (also known as “flash memory” or “random access memory” or “RAM”). Stored Social Network, Online Activity & Profile Information 32 is enclosed, stored, and modeled in data model 31 and processed, organized, and directed by communications processor 30. Activity information 33 represents the data storage memory buffer where all activity data is stored for use by the data model 31 and communications processor 30. Activity information 33 contains potential recommendations and all the information on activities required to generate recommendations. Activity information 33 comprises a relational DBMS, tables, or data elements which store data on a hard disk, solid state disk, other storage devices, and in active memory. Connection 65 represents a logical connection between all of the components within the present invention local implementation 50. Connection 65 is software integration and a hardware bus. Those skilled in the art will also appreciate that other integrations between components may be used without limiting the scope of the present invention.

Connection 63 represents the secure and insecure connections between the present invention local implementation 50 and the publicly-addressable Public Internet 42. Connection 63 is a networking connection of any protocol, bandwidth, throughput, or speed made available via local networks, wireless networks, cellular networks, satellite networks, infrared networks, and all networks over which data can travel, including IP and wireless protocols. Public Internet 42 is an IP network capable of transmitting data. Connection 63 may also be non-existent for use of the present invention as a stand-alone system. Connection 64 represents high-speed connections made through the publicly-addressable Internet or any other network capable of transmitting IP data. Those skilled in the art will appreciate that other network configurations may be used without limiting the scope of the present invention.

Web application 43 represents the centralized portal component of the present invention, available via the Internet or any other network capable of transmitting IP data and publicly addressable by all devices capable of connecting to the Internet. Web application 43 provides for the sharing of activities, creation of new activities, storing preferences, storing past usage data and log information, transmission of data relating to processing a recommendation into a user's life including calendar scheduling, messaging, reservation creation/responses, etc., and storing data used to improve the present invention in the future. Web application 43 is the computer software, hardware, stored data, preferences, and control logic that comprises the present invention's centralized portal and sharing hub. Present invention local implementation 50 connects to Web application 43 via connections 63 and 64, both securely and insecurely.

Web server 44 represents the processing and logic portion of Web application 43. Web server 44 has web serving, file serving, and works with all IP networking connectivity protocols for both secure and insecure communications. Web server 44 may comprise multiple servers working together to service the traffic requirement of Web application 43. Web server 44 has processing capabilities that allow it to statistically process usage and activity data to provide real-time and historical data to present invention local implementation 50. Web server 44 hosts connections with all implementations of the present invention local implementation 50, Internet websites 40, and Social Networking systems 41. Web server 44 receives data from Internet websites 40 and Social networking system 41 synchronously and asynchronously. Web server 44 can proactively retrieve information directly from Internet websites 40 and Social networking system 41 via ad hoc, scheduled, or regular requests. Web server 44 can receive information directly from Internet websites 40 and Social networking system 41 via, scheduled, or regular transmissions. Stored data 45 represents the data storage memory buffer of all data within Web application 43. Stored data 45 is a relational DBMS, tables, or data elements which store data on a hard disk, solid state disk, other storage devices, and in active memory. Those skilled in the art will appreciate that other configurations may be used without limiting the scope of the present invention.

Internet websites 40 represents all websites available via the publicly-addressable Public Internet 42 or any other network capable of transmitting IP data. Social Networking systems 41 represents all social networking sites available via the publicly-addressable Public Internet 42 or any other network capable of transmitting IP data. User 10 can provide authentication data to Internet websites 40 and Social Networking systems 41 connect via present invention local implementation 50 or directly to the end system via an interface of present invention local implementation 50. Internet websites 40 contains online activity data from user 10. Social networking systems 41 contains online activity data, social networking data, and social network connection data from user 10. Present invention local implementation 50 transmits data to and from Internet websites 40 and Social networking system 41 via connections 63 and 64 both securely and insecurely. Present invention local implementation 50 receives data from Internet websites 40 and Social networking system 41 synchronously and asynchronously. Present invention local implementation 50 can proactively retrieve information directly from Internet websites 40 and Social networking system 41 via ad hoc, scheduled, or regular requests. Present invention local implementation 50 can receive information directly from Internet websites 40 and Social networking system 41 via, scheduled, or regular transmissions. Present invention local implementation 50 interfaces directly with Internet websites 40 and Social networking system 41 via standardized APIs, through common user interactions, via screen-scraping technologies to retrieve information, or displays a view of information available via Internet websites 40 and Social networking system 41. Those skilled in the art will appreciate that other communications and interface mechanisms can be used without limiting the scope of the present invention.

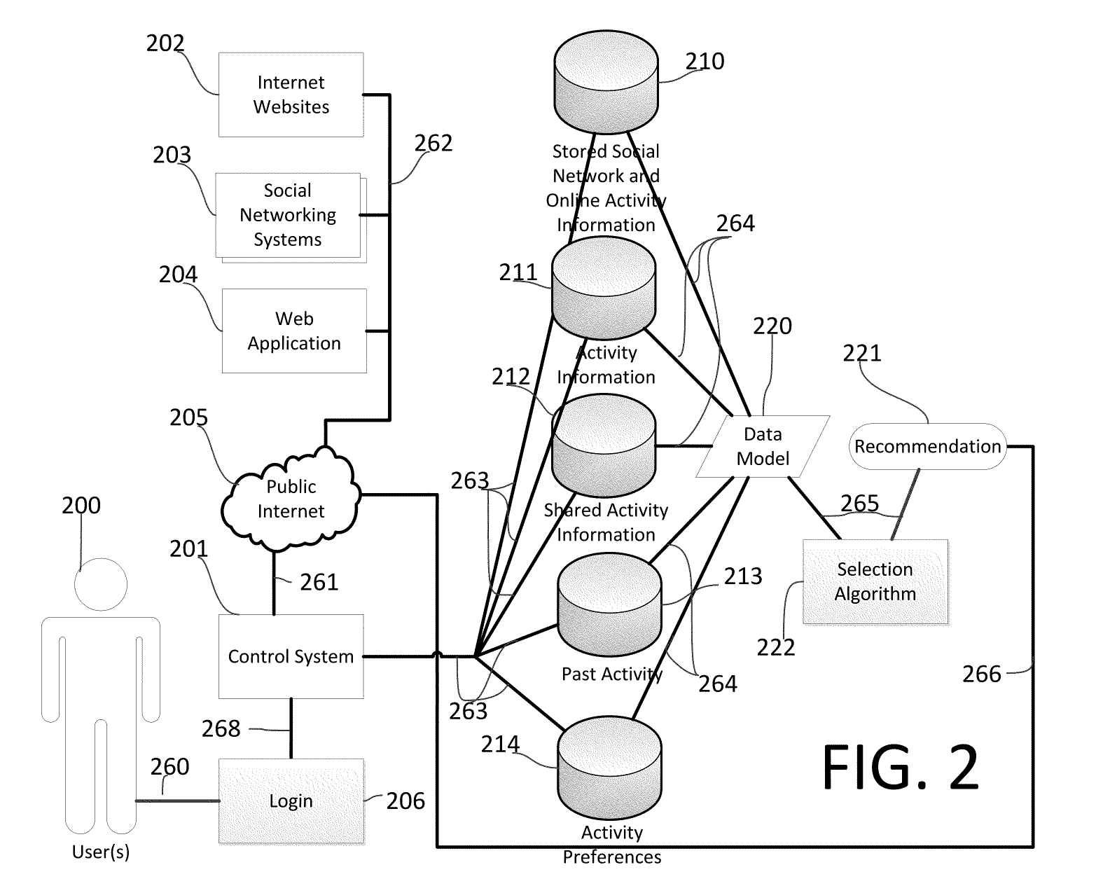

FIG. 2 is a block diagram which shows the present invention's process for retrieving and storing information from social networking sites and public Internet websites, using this information to generate customized and personalized recommendations, sharing these recommendations with social networks, online websites, and other users, and processing accepted recommendations into the user's life. User 200, or a group of users, interfaces with the present invention via connection 260, as stated above for Connection 60 in FIG. 1. Login 206 shows the secure login mechanism to the present invention. Through this login 206, the User 200 can securely authenticate to the present invention, to social networking websites, and to public Internet websites. Authentications can be stored or cached and used for future uses. Authentication can be based on password, image, voice, gesture, or biometrics. Those skilled in the art will appreciate that other communications and login mechanisms can be used without limiting the scope of the present invention.

Control system 201 represents the logic, control, and processing component of the present invention which runs on the user 200's device. Control system 201 represents the same component as described in Communications processor 30 in FIG. 1. Connection 268 represents the logical connection that internal components within the present invention securely communicate and transmit data. Connection 268 represents the same connections as described with Connection 65 in FIG. 1. Control system 201 works independently of and at the request of user 200. Asynchronous and synchronous processes run via an internal scheduler at specified intervals and times of the day or year. Asynchronous and synchronous processes run as required by the interactions of the user or data feeds initiated by outside systems. Those skilled in the art will appreciate that other configurations can be used without limiting the scope of the present invention.

Connection 261 is a network connection of any protocol, bandwidth, throughput, or speed made available via local networks, wireless networks, cellular networks, satellite networks, infrared networks, and all networks over which IP data travels. Connection 261 represents the same connections as described with Connection 63 in FIG. 1. Public Internet 205 is either the Internet or any other network capable of transmitting data. Public Internet 205 is also an intranet for an installation of the present invention available within a private network. Connection 262 represents high-speed connections made through the publicly-addressable Internet or any other network capable of transmitting IP data. Those skilled in the art will appreciate that other configurations can be used without limiting the scope of the present invention.

Internet websites 202 represents all websites available via the publicly-addressable Public Internet 205 or any other network capable of transmitting IP data. Social Networking systems 203 represents all social networking sites available via the publicly-addressable Public Internet 205 or any other network capable of transmitting IP data. Control system 201 transmits data to and from Internet websites 202 and Social networking systems 203 via connections 261 and 262 both securely and insecurely. Control system 201 receives data from Internet websites 202 and Social networking systems 203 synchronously and asynchronously. Control system 201 can proactively retrieve information directly from Internet websites 202 and Social networking systems 203 via ad hoc, scheduled, or regular requests. Control system 201 can proactively receive information directly from Internet websites 202 and Social networking systems 203 via, scheduled, or regular transmissions. Control system 201 interfaces directly with Internet websites 202 and Social networking systems 203 via standardized APIs, through common user interfaces, via screen-scraping technologies to retrieve information presented from the system, or show a view of information available via Internet websites 202 and Social networking systems 203. Control system 201 can retain all online persona and other data obtained from Internet websites 202 and Social Networking systems 203 in a DBMS, table, cache, or active memory or based on configuration, Control system 201 can purge this data after use for security and data privacy concerns. Internet websites 202 comprise the same components as described with Internet websites 40 in FIG. 1. Social Networking systems 203 comprise the same components as described with Social Networking systems 41 in FIG. 1. Those skilled in the art will appreciate that other communications mechanisms and configurations can be used without limiting the scope of the present invention.

Web application 204 represents the centralized portal component of the present invention, available via the Internet or any other network capable of transmitting data and publicly addressable by all devices capable of connecting to the Internet or any other network capable of transmitting IP data. Web application 204 provides for the sharing of activities, creation of new activities, storing preferences, storing past usage data and log information, and storing data used to improve the present invention in the future by the control system 201. Control system 201 connects to Web application 204 via connections 261 and 262 both securely and insecurely. Web application 204 comprises the same components as described with Web application 43 in FIG. 1. Web application 204 can share activities and activity recommendations via communication on Social Networking systems 203, via Internet websites 202, via the present invention, or via devices that the present invention resides on. Web application 204 receives information from users that they wish to share and then shares this data with selected or all users based on settings. This is achieved by making this data available to the targeted users, communicating with the targeted users that this shared data is available, and by allowing the targeted users to retrieve this shared data on their request. Web application 204 will also generate lists of the most shared activities, most popular activities, most creative activities, and other contests where users can win points or money. This information is available via Web application 204 and readily accessible and shareable to Social Networking systems 203, Internet websites 202, and the present invention. Web application 204 can host group activities that user 200 can receive and subsequently accept a recommendation to participate in; these events can be local, regional, national, or global and be based on any activity in the system. These events can be created by the present invention or by its users. Those skilled in the art will appreciate that other configurations can be used without limiting the scope of the present invention.

Connections 263 represent the logical secure connections within the present invention that connect the control system 201 with its internal data storage components: Stored Social Network and Online Activity Information 210, Activity information 211, Shared activity information 212, Past activity 213, and Activity preferences 214. Connections 263 represents the same connections as described with Connection 65 in FIG. 1. Stored Social Network and Online Activity Information 210, Activity information 211, Shared activity information 212, Past activity 213, and Activity preferences 214 are relational DBMS, tables, or data elements which store data on a hard disk, solid state disk, other storage devices, and in active memory. Stored Social Network and Online Activity Information 210, Activity information 211, Shared activity information 212, Past activity 213, and Activity preferences 214 store information in compressed and uncompressed formats. Compressed formats include compression algorithms and language-based reductions of common words, phrases, and connective words. Data is normalized against existing system data and common activities, common keywords, and other common data are merged. Those skilled in the art will appreciate that other configurations, storage techniques, compression techniques, and normalization techniques can be used without limiting the scope of the present invention.

Stored Social Network, Online Activity & Profile Information 210 represents the data storage where all internal and external data relating to social network systems 203 data, Internet websites 202 activity data, profile data, preferences, check-ins, posts, preferences and selection criteria data from Web application 204, and all other collected and cached data from the Public Internet 205 is stored. Data is transformed and normalized to allow for the correlation and systematic comparison between data from all users. Those skilled in the art will appreciate that other configurations can be used without limiting the scope of the present invention.

Activity information 211 represents the data storage where all activity data for use in generating recommendations is stored. Shared activity information 212 represents the data storage where all activity data that was shared from other users or via the Web application 204 for use in generating recommendations is stored. Activity information 211 represents the same connections as described with Activity information 33 in FIG. 1. Those skilled in the art will appreciate that other configurations can be used without limiting the scope of the present invention.

Past activity 213 represents the data storage where all past usage data from the present invention and correlated usage data from Web application 204 is stored. Past activity 213 stores all past usage, logging, user decisions, and system decisions. Data is transformed and normalized to allow for the correlation and systematic comparison between data from all users. Activity preferences 214 represents the data storage where all activity preference and activity weighting data is stored. When user 200 gives a weighting to an activity or removes an activity from their future recommendations, this information is stored in Activity preferences 214, along with activity preference information processed from the user 200's online persona. Control system 201 processes the user 200's online persona data and correlates this against the present invention's activity data and creates customized weightings, which are stored in Activity preferences 214. Stored Social Network and Online Activity Information 210, Shared activity information 212, Past activity 213, and Activity preferences 214 represent objects contained with Stored Social Network, Online Activity & Profile Information in FIG. 1. Those skilled in the art will appreciate that other configurations can be used without limiting the scope of the present invention.

Connections 264 represent the logical secure connections and hardware connections within the present invention that connect the data model 220 with its internal data storage components: Stored Social Network and Online Activity Information 210, Activity information 211, Shared activity information 212, Past activity 213, and Activity preferences 214. Connections 264 represents the same connections as described with Connection 65 in FIG. 1. Those skilled in the art will appreciate that other configurations can be used without limiting the scope of the present invention.

Data model 220 represents the data model whereby all data stored in or collected by the present invention is logically stored, data relationships are created and established, and all objects represented within the present invention, together with their properties and relationships are logically stored. The present invention transforms all available data, from its internal data storage components: Stored Social Network and Online Activity Information 210, Activity information 211, Shared activity information 212, Past activity 213, and Activity preferences 214, about the user's online history and profile information into correlation tables within Data model 220 for generating recommendations. Data model 220 represents the same component as described with Data model 31 in FIG. 1. Those skilled in the art will appreciate that other configurations can be used without limiting the scope of the present invention.

Connections 265 represents the logical connections within the present invention between the Data model 220 and the Selection algorithm 222 that the control system 201 uses to process a recommendation based on all the data in its internal data storage components and the data in data model 220 and deliver to Recommendation 221. Connections 265 represents the same connections as described with Connection 65 in FIG. 1. Those skilled in the art will appreciate that other configurations can be used without limiting the scope of the present invention.

Selection algorithm 222 is the computational logic that processes, compares, correlates, models, and transforms the data held within data model 220 to generate a customized and personalized recommendation for user 200. Selection algorithm is a system of computer software, computer hardware, and data correlations used to statistically model the activities within the system against the online persona(s) of user 200. The data within the data model 220 is searched for keywords related to all activities within the system, correlated against preferences, correlated against check-in location information, correlated against preferences and check-in location information of socially-networked connections, correlated against time, location, seasonality, and other environmental factors, correlated against the user(s)′ profile(s), compared with connected and disconnected users' past activities, recommendations, and preferences, compared with the user's mood or biological factors, compared against previous responses and weightings for each activity, and statistically modeled. Each statistically relevant activity entered into the random selection based on a weighting for that activity or the most statistically significant activity can be chosen as the generated recommendation or the activity with the most correlations to the user's online persona can be chosen or the event most often accepted by correlated, connected and non-connected users. Selection algorithm 222 then presents the user with Recommendation 221 via the present invention. Those skilled in the art will appreciate that other configurations and data modeling techniques can be used without limiting the scope of the present invention.

Recommendation 221 is the resulting recommendation generated for the user 200 with all available data in data model 220 and the current online persona represented by the data in the system's internal data storage components: Stored Social Network and Online Activity Information 210, Activity information 211, Shared activity information 212, Past activity 213, and Activity preferences 214. User 200 can accept this recommendation and choose to share this recommendation with social networking systems 203, public Internet websites 202, Web application 204, email, text messaging, other forms of electronic communication, voice calls, and any native output of the device the present invention is executing on or being run from. User 200 can accept this recommendation and choose to process this recommendation into his real life by scheduling himself and others via calendaring applications available on the device the present invention is executing on or via network-available calendars and Web application 204. Accepting the Recommendation 221 will also, by configuration, process this recommendation into the real lives of the user's connections by scheduling them and confirming reservations via calendaring applications available on their device(s) or via network-available calendars and/or Web application 204, send verbal and written, electronic acknowledgements to event organizers, schedule calendar events, create reservations for restaurants and public establishments, send communications to contact lists, send information to the user 200's device for reminders, post to Social Networking systems 203, and send information to GPS, mapping, and direction-providing appliances for navigation purposes. Those skilled in the art will appreciate that other configurations and communications can be used without limiting the scope of the present invention.

If user 200 elects to reject Recommendation 221, the present invention will log this user decision and generate a new recommendation based on the previous settings and preferences and the updated inputs. The present invention will also allow the user 200 to create or modify new settings, inputs, and preferences.

Connection 266 represents the present invention's connection to the Internet for both secure and insecure data transmissions. Connection 266 and Connection 261 represent the same network connection.

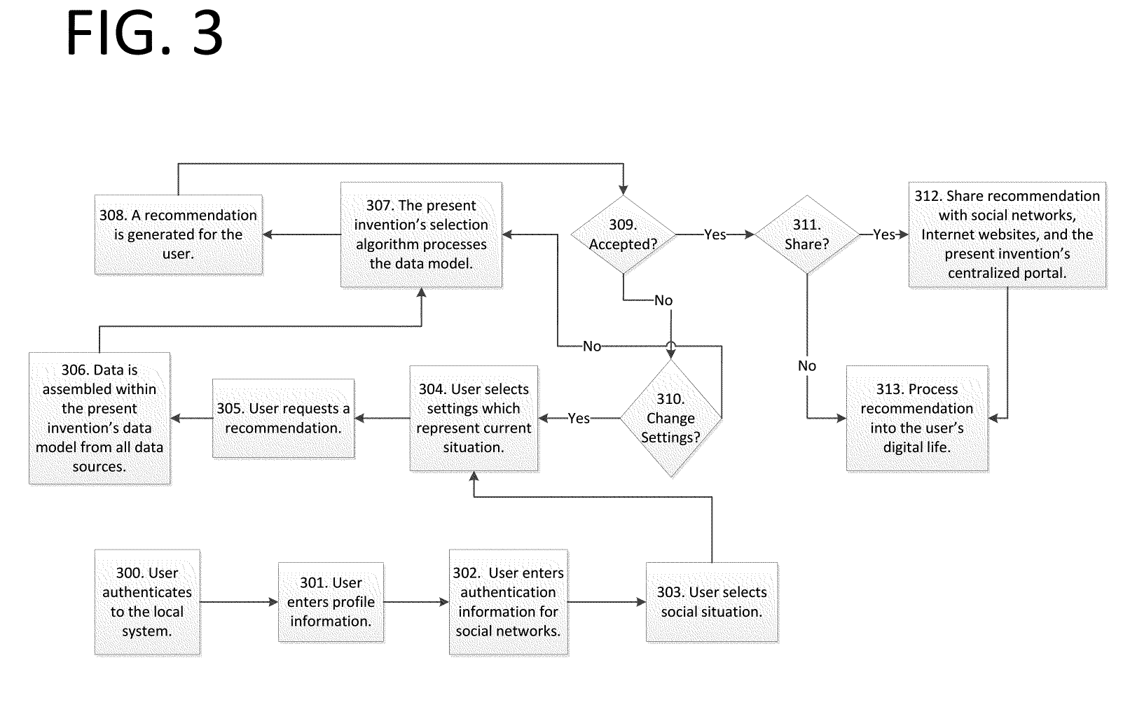

FIG. 3 shows a flow chart representation of an example first use of the present invention. The user authenticates to the local system 300 and enters their biographic profile information into the system 301. The user then securely enters authentication data for any or all of their social networking sites 302. The user then selects the current social situation, for example, if they are alone or in a group and if they are in a group they will enter the group's composition 303. The user then selects the settings and preferences which best describe their current situation 304. These settings and preferences are entered into the system as user-selected inputs, data from peripherals, and data from Internet data sources. The user can enter as many or as few of the settings as they choose. The user then asks for a recommendation via user input, tactile responses such as but not limited to shaking a mobile device, sounds, eye movements, or making body gestures 305. Those skilled in the art will appreciate that other configurations can be used without limiting the scope of the present invention.

Data is then assembled from all system resources and input into data model 306. The selection algorithm then processes the data model and all inputs 307 to produce a recommendation 308. The user then implicitly or explicitly chooses to accept the generated recommendation 309. If the user accepts the generated recommendation, then the user is then prompted to share the recommendation 311. If the user rejects the generated recommendation, then the user is prompted to change settings 310. If the user implicitly or explicitly chooses to not change the settings, then the selection algorithm re-processes the data model 307 or the data model will be updated and readied for another use. If the user implicitly or explicitly chooses to change the settings, then the user is prompted to re-select settings which best represent the current situation. They can either add or remove settings. Those skilled in the art will appreciate that other configurations can be used without limiting the scope of the present invention.

Once the user is prompted to share the recommendation 311, then can either choose to share the generated recommendation or not. If they choose to share the recommendation, the recommendation is then shared with their social networking sites, Internet websites, the present invention's centralized portal, and all systems on their mobile device 312. This sharing mechanism can be configured within the profile so it occurs each time or configured at the moment of use so the user can selectively choose how to share the generated recommendation. Either, once the user has completed sharing the generated recommendation or the user elected to not share the generated recommendation, the generated recommendation is then processed by the user's device, social networks, Internet websites, and the present invention's centralized portal 313. This processing entails both automated and prompted responses to make reservations, respond with acknowledgements and reservations, send information to GPS, mapping, and direction-providing appliances for navigational purposes, send information to geographic check-in or tracking appliances, make calendar appointments for the user and their group, create reminders, update out of office messages and standards greeting on all of their forms of electronic communication, and notify a contact list of their plans to engage in the generated recommendation. Those skilled in the art will appreciate that other configurations can be used without limiting the scope of the present invention.

It is to be understood that the above described embodiments are merely illustrative of numerous and varied other embodiments which may constitute applications of the principles of the invention. Such other embodiments may be readily devised by those skilled in the art without departing from the spirit or scope of this invention and it is our intent they be deemed within the scope of our invention.

For example, other digital computer system configurations can also be employed to perform the method of this invention, and to the extent that a particular system configuration is capable of performing the method of this invention, it is equivalent to the representative digital computer system of FIG. 1, and within the scope and spirit of this invention.

Once such digital computer systems are programmed to perform particular functions pursuant to instructions from program software that implements the method of this invention, they in effect become special-purpose computers particular to the method of this invention. The techniques necessary for this are well-known to those skilled in the art of computer systems.

Computer programs implementing the method of this invention will commonly be distributed to users on a distribution medium such as floppy disk or CD-ROM or distributable download or a flash memory data storage device. From there, they will often be copied to a hard disk or a similar intermediate storage medium. When the programs are to be run, they will be loaded either from their distribution medium or their intermediate storage medium into the execution memory of the computer, configuring the computer to act in accordance with the method of this invention. All these operations are well-known to those skilled in the art of computer systems.

The term “computer-readable medium” encompasses distribution media, intermediate storage media, execution memory of a computer, or any other medium or device capable of storing for later reading by a computer a computer program implementing the method of this invention.

### REFERENCES CITED

1. US20120036523 A1 February 2012 Weintraub
2. US20120259791 A1 October 2012 Zoidze
3. EP2526382 A1 November 2012 Das
4. US20130005478 A1 January 2013 McCaffery
5. US20130024464 A1 January 2013 Berner
6. U.S. Pat. No. 8,489,515 B2 July 2013 Mathur
7. U.S. Pat. No. 8,555,173 B2 October 2013 Kast

What is claimed is:

1. A system for decision making and activity recommendations that produces recommendations, customized and personalized via the user's or users' online personas, comprising:
a. A user interface available via a local or remote implementation;
b. A control software program that orchestrates the decision making and recommendations engine;
c. A data model that comprises all of the data available to the decision making and recommendations engine;
d. A selection algorithm that the software control system executes to generate customized and personalized recommendations;
e. A set of data storage devices that hold stored social networking data, online website activity data, profile information, and all other collected and cached data is stored;
f. A set of data storage devices that hold stored activity information data relevant for the recommendation engine to select from and generate recommendations from;
g. A security mechanism to maintain and protect all user information from theft or tampering;
h. A centralized data storage and processing resource of the present invention;
i. A set of secure interfaces for the transmission of data between the present invention and social networking sites, public Internet websites, user devices, and all electronic communication;
j. An Internet connection that provides both secure and insecure connectivity to social networking sites, public Internet websites, and the centralized portal of the present invention; and
k. A processing engine that provides for automated and prompted actions resulting from an accepted recommendation.

2. A decision making and activity recommendations method as recited in claim 1, wherein current settings related to the user can be set including:
a. information related to the users' preferences;
b. information related to the time of day;
c. information related to the date;
d. information related to when the activity will take place;
e. information related to the current day of the week;
f. information related to the current or future planning time;
g. information related to whether the user is on vacation or has the currently-selected or adjacent time off from work, school, or other responsibilities;
h. information related to cost levels;
i. information related to indoor or outdoor settings;
j. information related to the current location;
k. information related to the current season;
l. information related to food inclusion/exclusion;
m. information related to preferences for a combination of food and an activity;
n. information related to alcohol inclusion/exclusions;
o. information related to current mood of the user and their group;
p. information related to locations and activities that welcome pets;
q. information related to the number of activities the user has been on with their romantic date or activity partner(s);
r. information related to the users' relationship statuses;
s. information related to the users' sexual orientation and lifestyle;
t. information related to gender identification;
u. information related to dress code;
v. information related to group size and composition including gender count, ages, relationship statuses, personalities, preferences, sexual orientations, and all other settings available to an individual user;
w. information related to counts and ages of children and juveniles in the group;
x. information related to types of family-friendly activities desired including play dates, educational activities, and delineation of types of play;
y. information related to the users' desire to do something productive, e.g. accomplishing portions of their task list, errands, or to do list;
z. information related to the users' favorite activities, favorite places to go, favorite restaurants, favorite bars/taverns, etc.;
aa. information related to the users' preferences for utilizing coupons or specials;
bb. information related to the users' medical history;
cc. information related to the users' biological information;
dd. information related to the users' exercise routine;
ee. information related to the users' work schedule;
ff. information related to the users' vacation schedule;
gg. information related to the users' holiday schedule;
hh. information related to the users' family's schedule;
ii. information related to the users' time commitments and responsibilities;
jj. information related to the level of effort or planning required for a recommended activity; and
kk. information related to the users' decision to be bound to the generated recommendation for processing.

3. A decision making and activity recommendations method as recited in claim 1, wherein the user can create, modify, or import a profile with configurations related to the user including:
a. Information related to the gender of the user;
b. Information related to the relationship status of the user;
c. Information related to the age of the user;
d. Information related to the current and past locations of the user;
e. Information related to the preferences of the user;
f. Information related to the history of the user;
g. Information related to the personality type of the user including the resulting answers from a personality questionnaire;
h. information related to the users' relationship statuses;
i. Information related to the socio-economic status of the user;
j. Information related to the social networking profiles of the user;
k. Information related to the social networking profiles of the user's connections;
l. Information related to the education history of the user;
m. Information related to the media viewership history of the user;
n. Information related to the intelligence of the user;
o. Information related to the culture of the user;
p. information related to the favorite activities, favorite places to go, favorite restaurants, favorite bars/taverns of the user;
q. information related to level of effort or required planning levels; and
r. information related to data available on the user's device, comprising but not limited to:
i. contact list data;
ii. electronic communication history data;
iii. events calendar data;
iv. reminders;
v. biographic information;
vi. biological information for health-related monitoring and inputs;
vii. weather-related information;
viii. photographs; and
ix. videos.

4. A decision making and activity recommendations method as recited in claim 1, wherein information is used and potentially stored for use from:
a. Social networking sites;
b. Internet websites;
c. Ecommerce sites;
d. User's device;
e. User's connections' devices; and
f. Present invention.

5. A decision making and activity recommendations method as recited in claim 1, wherein activities can be created, reviewed, updated, or deleted including facilities to:
a. Add new activities;
b. Save and archive existing, new, or shared activities;
c. Import new or saved activities;
d. Reset activities to revision levels;
e. Synchronize activities with any or all of their social network;
f. Modify existing, new, or shared activities;
g. Review existing, new, or shared activities;
h. Delete existing, new, or shared activities; and
i. Share new, previously shared, or modified activities with other users or via social networking sites.

6. A decision making and activity recommendations method as recited in claim 1, wherein the decision making and recommendations engine has a centralized portal component that can:
a. Host and store activity information for download and import into the present invention;
b. Facilitate users creating and sharing new activity information for download or import into the present invention;
c. Facilitate the sharing of popular activities with all users of the present invention;
d. Host a leader board of sharing, contests, and various top 10-style lists of activities;
e. Facilitate the sharing of activities between users;
f. Facilitate the sharing of activities between users on social networking sites or public Internet websites;
g. Facilitate the sharing of photographs, audio recordings, video recordings, and other memorabilia of the recommended activities between users;
h. Facilitate the creation of and hosting of group events on a local, regional, state, national, or worldwide scale that can be recommended for users to attend;
i. Facilitate romantic dating between users;
j. Host a dating service and accompanying website for users;
k. Host singles parties and events on a local, regional, state, national, or worldwide scale;
l. Serve as a gateway for upgrades to the present invention's software and updates to its internal data;
m. Serve as a repository for shared activity data and related shared information;
n. Serve as a repository for preference data and normalized preference data for use in generating future recommendations and functionally creating a learning computer system; and
o. Facilitate the processing of accepted recommendations via electronic communications, including but not limited to the acknowledgement of reservations, the making of reservations, calendar scheduling, create reminders for the user's calendar and device, links, printing, forwarding, or redeeming coupons.

7. A decision making and activity recommendations method as recited in claim 1, wherein the user can choose to allow the present invention to plan their day for them. Users participate in each recommendation as given and the present invention could instruct the user(s) on what to do with their lives and how to live their lives including but not limited to terms of responsibilities, things they have to do, commitments, social engagements, free time activities, family activities, etc. This could be arranged by:
a. The choice of the user;
b. A governing body or person as a form of punishment or oversight; or
c. A governing body or person as a form of rehabilitation from injury or addictions.

8. A decision making and activity recommendations method as recited in claim 1, wherein the user or user's group can:
a. Securely authenticate to the present invention, the centralized portal, all social networking systems, and all Internet websites;
b. Retrieve their online persona from social networking sites and public Internet sites visited or interacted with and, by configuration, either use that information immediately without storing it or securely store that information locally as a cache for future use;
c. Share their recommendations with their social networks or on online Internet websites;
d. Enable or disable different features of the selection algorithm, either permanently or temporarily;
e. Configure whether the decision making and recommendations method stores any online Internet data;
f. Securely connect to all Internet resources and have security provided for stored and/or cached data; or
g. Enroll in a dating service component of the present invention and engage in singles activities arranged and hosted by the present invention.

9. A decision making and activity recommendations method as recited in claim 1, wherein the user can tune the recommendation engine via:
a. the weighting of recommendations positively or negatively to influence the data model and subsequently those activities' appearances in future recommendations for this user, related uses, connected users, and similar users.
b. Creating limitations on an activity that would limit when it would be recommended, how often it would be recommended, and criteria that influence when this activity is selected including relationships to other activities, keywords, preferences, etc.;
c. Recommendations, weightings, limitations, feedback, and preferences of their social network connections;
d. Denying a recommendation in favor of a newly-generated recommendation; and
e. Whether an accepted recommended activity was carried out.

10. A decision making and activity recommendations method as recited in claim 1, wherein each action the user takes within the decision making and recommendations engine is stored for future use in making recommendations, including actions such as:
a. A recommendation is accepted;
b. A recommendation is rejected;
c. A recommendation is shared;
d. An activity is created;
e. An activity is modified;
f. An activity is deleted;
g. An activity is shared;
h. An activity is carried out;
i. An event is created;
j. Invitations, reservations, or reservation responses are sent out;
k. How many settings are currently set;
l. If new settings are selected after a rejected recommendation;
m. Changes to the user's profile;
n. Social networking system activities; and
o. Online websites activities.

11. A decision making and activity recommendations method as recited in claim 1, wherein the decision making and recommendations method can give specific recommendations based on factors such as:
a. Current location;
b. Favorite activities;
c. Favorite restaurants;
d. Favorite bars, taverns, clubs, and other public, social establishments;
e. Favorite cafes, coffee houses, amusement parks, entertainment facilities, public parks, friend's houses, and other public places;
f. Events near the user's location;
g. Special prices being offered, coupons being offered, a published advertisement, or sales occurring near the user's location; and
h. Preferences of the user's socially-networked connections.

12. A decision making and activity recommendations method as recited in claim 1, wherein the decision making and recommendations engine can give specific recommendations such as:
a. A specific restaurant to eat at;
b. A specific bar or other public, social establishment to meet at;
c. A specific golf course or other sporting location to play at;
d. A specific vacation destination;
e. A specific place to go;
f. A specific event to attend; and
g. A specific activity to engage in, either in the local vicinity or outside of it.

13. A decision making and activity recommendations method as recited in claim 1, wherein the decision making and recommendations engine can give recommendations based on paid or unpaid advertisements comprising:
a. Paid, general advertisements;
b. Paid, targeted advertisement based on matching requirements against a user or user group's profiles and online personas;
c. Unpaid advertisement for highly-reviewed or local spotlight activities or locations;
d. Targeted sales leads for recommendations involving advertising and sponsoring companies;
e. Dating services; and
f. Events hosted by the present invention.

14. A decision making and activity recommendations method as recited in claim 1, wherein the decision making and recommendations method can provide links and additional information for each recommendation comprising:
a. Coupons;
b. Advertisements;
c. Special prices being offered, coupons being offered, a published advertisement, or sales occurring;
d. Sales leads for recommendations involving advertising and sponsoring companies;
e. Links from the user's social network;
f. Informational videos and links to informational videos;
g. Links to websites within the present invention's central portal with additional information;
h. Links to external websites with additional information; and
i. Links on recommendations for additional information, scheduling, etc.

15. A decision making and activity recommendations method as recited in claim 1, wherein the decision making and recommendations method can prioritize and select an activity from a task list, taking into account data comprising:
a. Location;
b. The user's task list;
c. Time available;
d. The user's future schedule;
e. Skills required;
f. Future commitments and responsibilities;
g. Amount of planning and preparation required; and
h. Hours of operation of necessary components of the task list.

16. A decision making and activity recommendations method as recited in claim 1, wherein the decision making and recommendations method take group composition into account when generating recommendations, comprising:
a. Alone time;
b. Romantic dates;
c. Group romantic dates;
d. Group activities;
e. Family activities; and
f. Any social activity based on the composition of that group.

17. A decision making and activity recommendations method as recited in claim 1, wherein the decision making and recommendations method parses, transforms, and indexes all online Internet data via methods comprising:
a. Compression algorithms;
b. Text transformations;
c. Pruning common words and phrases;
d. Pruning words and phrases with multiple meanings; and
e. Removing all words except for nouns and verbs.

18. A decision making and activity recommendations method as recited in claim 1, wherein the user can either temporarily or permanently link their implementation of the decision making and recommendations method with others for:
a. Generating recommendations for a group; and
b. Generating recommendations based on the account and account history of a connection.

19. A decision making and activity recommendations method as recited in claim 1, wherein the user can either temporarily or permanently link their implementation of the decision making and recommendations engine by:
a. Configuring their implementation of the decision making and recommendations method to link to another implementation;
b. Configuration via social networking systems or Internet websites;
c. Wireless connectivity;
d. Wired connectivity; and
e. Physically touching devices.

20. A decision making and activity recommendations method as recited in claim 1, wherein the system is a learning computer system using previous usage data, statistical information, and data indicating user tendencies to generate better targeted recommendations in the future.
